(19) United States
(12) Patent Application Publication
(10) Pub. No.: US 2024/0296578 A1
(43) Pub. Date: Sep. 5, 2024

(54) ESTIMATING FORESTRY TIMBER VOLUMES

(71) Applicant: Maxar International Sweden AB, Linköping (SE)

(72) Inventors: Gustav TAPPER, Linköping (SE); Carl SUNDELIUS, Linköping (SE); Thomas BECKMAN, Linköping (SE); Erica STRAND, Linköping (SE); Gustav DAHMÉN, Stockholm (SE)

(73) Assignee: Maxar International Sweden AB, Linköping (SE)

(21) Appl. No.: 18/177,270

(22) Filed: Mar. 2, 2023

(51) Int. Cl. G06T 7/62; G06V 20/10

(52) U.S. Cl. CPC G06T 7/62; G06V 20/188; G06T 2207/20081; G06T 2207/30188

(57) ABSTRACT

Forestry timber volume estimations may be provided. In a three-dimensional Digital Surface Model (DSM), a plurality of image data associated with a respective plurality of trees may be identified. Then, from the plurality of image data, species data associated with each of the plurality of trees may be determined. A height above ground may then be determined for each of the plurality of trees by subtracting a height of ground associated with each of the plurality of trees determined from a three-dimensional Digital Terrain Model (DTM) from a height of tree associated with each of the plurality of trees determined from the three-dimensional DSM. A volume associated with each of the plurality of trees may be determined based on the height of tree associated with each of the plurality of trees and the species data associated with each of the plurality of trees.

### TECHNICAL FIELD

The present disclosure relates generally to estimating forestry timber volumes.

### BACKGROUND

Satellite images are images of Earth collected by imaging satellites operated by governments and businesses around the world. Satellite imaging companies sell images by licensing them to governments and businesses. Satellite images have many applications in meteorology, oceanography, fishing, agriculture, biodiversity conservation, forestry, landscape, geology, cartography, regional planning, and education. Images may be in visible colors and in other spectra. There are also elevation maps, usually made by radar images. Image interpretation and analysis of satellite imagery may be conducted using software.

Forests are a renewable resource that may contribute to a nation's economy. The forest may also serve many other purposes, such as providing clean air, contributing to biodiversity, and being a source of food. Maintaining and keeping a forest healthy may be vital for humans.

### BRIEF DESCRIPTION OF THE FIGURES

The accompanying drawings, which are incorporated in and constitute a part of this disclosure, illustrate various embodiments of the present disclosure. In the drawings:

FIG. 1 is a diagram of an operating environment for providing forestry timber volume estimations;

FIG. 2 is a flow chart of a method for providing forestry timber volume estimations;

FIGS. 3A and 3B illustrate a visual representation of a three-dimensional Digital Surface Model (DSM); and

FIG. 4 is a block diagram of a computing device.

### DETAILED DESCRIPTION

### Overview

Forestry timber volume estimations may be provided. In a three-dimensional Digital Surface Model (DSM), a plurality of image data associated with a respective plurality of trees may be identified. Then, from the plurality of image data, species data associated with each of the plurality of trees may be determined. A height above ground may then be determined for each of the plurality of trees by subtracting a height of ground associated with each of the plurality of trees determined from a three-dimensional Digital Terrain Model (DTM) from a height of tree associated with each of the plurality of trees determined from the three-dimensional DSM. A volume associated with each of the plurality of trees may be determined based on the height of tree associated with each of the plurality of trees and the species data associated with each of the plurality of trees.

Both the foregoing overview and the following example embodiments are examples and explanatory only, and should not be considered to restrict the disclosure's scope, as described and claimed. Furthermore, features and/or variations may be provided in addition to those described. For example, embodiments of the disclosure may be directed to various feature combinations and sub-combinations described in the example embodiments.

### Example Embodiments

The following detailed description refers to the accompanying drawings. Wherever possible, the same reference numbers are used in the drawings and the following description to refer to the same or similar elements. While embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

Consistent with embodiments of the disclosure, a comparison between a three-dimensional Digital Surface Model (DSM) and a three-dimensional Digital Terrain Model (DTM) may be used to detect a quantity, calculate a volume, and detect growth on a larger scale of a forest. The estimations of the tree volume produced by using these three-dimensional models may be used in the logging industry to evaluate current and future forest volumes. In addition, using three-dimensional models of a forest several taken at different times (e.g., years apart) may provide data about the growth of the forest. Embodiments of the disclosure may be performed rapidly for large scale areas, such as states or countries.

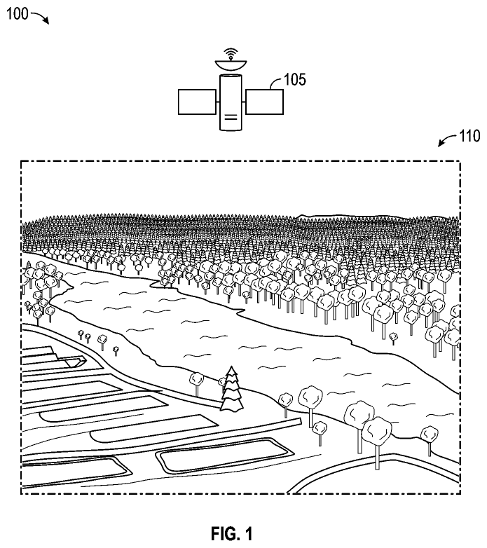

FIG. 1 shows an operating environment 100 for providing forestry timber volume estimations. As shown in FIG. 1, operating environment 100 may comprise a satellite 105 and a forest 110. Satellite 105 may comprise a commercial Earth observation and imaging satellite used or designed for Earth Observation (EO) from orbit, including environmental monitoring, meteorology, cartography, and others. Satellite 105 may collect images in panchromatic and multispectral bands for example. The orbiting altitude of satellite 105 may comprise, but is not limited to, 617 km. Satellite 105 may be used to take images of forest 110.

Embodiments of the disclosure may use the images of forest 110 taken by satellite 105 to produce three-dimensional geodata models using three-dimensional reconstruction from these satellite images. For example, a three-dimensional DSM may be constructed from these images that may describe the three-dimensional surface of the landscape of forest 110. In addition, a DTM may be created from the DSM that may describe the ground level under forest 110. The DTM may be created, for example, by excluding objects on the ground in the DSM and interpolating between ground points near these objects. A height above ground level may be represented by a Digital Height Model (DHM) that may be calculated by subtracting the DTM from the DSM. Accordingly, embodiments of the disclosure may create models that may describe a height and texture of forest 110 that may be used in determining a value of forest 110. Consequently, embodiments of the disclosure may perform an automatic inventory of forests from the aforementioned three-dimensional models.

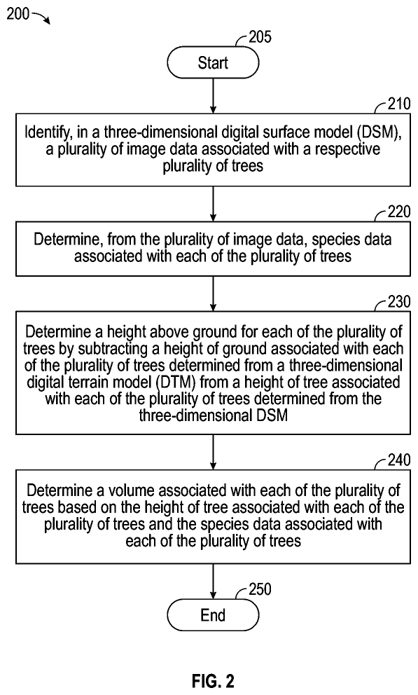

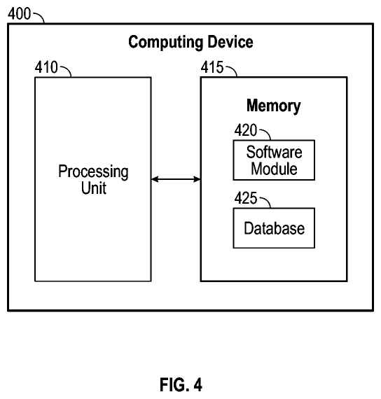

FIG. 2 is a flow chart setting forth the general stages involved in a method 200 consistent with embodiments of the disclosure for providing forestry timber volume estimations. Method 200 may be implemented using a computing device 400 as described in more detail below with respect to FIG. 4. Ways to implement the stages of method 200 will be described in greater detail below.

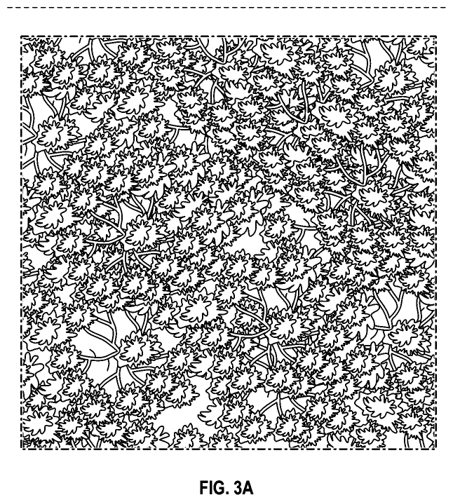

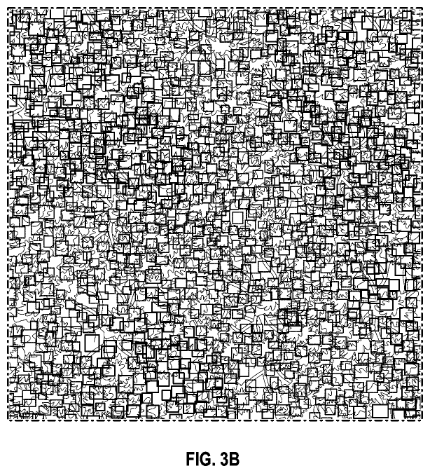

Method 200 may begin at starting block 205 and proceed to stage 210 where computing device 400 may identify, in a three-dimensional Digital Surface Model (DSM), a plurality of image data associated with a respective plurality of trees. For example, FIG. 3A may comprise a visual representation of the three-dimensional DSM associated with forest 110. FIG. 3B may comprise a visual representation of the three-dimensional DSM associated with forest 110 with the plurality of image data associated with the respective plurality of trees shown as bounding boxes. Each bounding box may encompass a tree in forest 110. A Machine Learning Model (MLM) may be trained and used on the three-dimensional DSM in order to detect and identify the image data for the trees in the three-dimensional DSM. The MLM may comprise, but not limited to, an Artificial Neural Network (ANN), a Deep Neural Network (DNN), or a Convolutional Neural Network (CNN).

From stage 210, where computing device 400 identifies, in the three-dimensional DSM, the plurality of image data associated with the respective plurality of trees, method 200 may advance to stage 220 where computing device 400 may determine, from the plurality of image data, species data associated with each of the plurality of trees. For example, the image data for each of the bounding boxes may be analyzed and species data of the trees associated with the bounding boxes may be determined from this analysis. An MLM may be trained and used to on the three-dimensional DSM in order to determine species data for the trees in the three-dimensional DSM. The MLM may comprise, but not limited to, an ANN, a DNN, or a CNN. With other embodiments of the disclosure, the same MLM may be used to determine both the plurality of image data associated with the respective plurality of trees and the species data associated with the respective plurality of trees in one stage.

Embodiments of the disclosure may determine the species data based on, for example, on: i) a canopy size of the tree taken from the image data associated the tree; ii) texture associated with the tree taken from the image data associated the tree; and iii) a color associated with the tree taken from the image data associated the tree. Climate from the area of the world the tree is in and time of year the images are taken may be considered in determine the species data. For example, in some northern climates during the fall of the year, some trees make change to different colors. The species data may comprise determining if the tree is coniferous and deciduous. The species data determination may go into more detail by determining a give species of the tree (e.g., Ponderosa pine, Aspen, Spruce, etc.).

Once computing device 400 determines, from the plurality of image data, species data associated with each of the plurality of trees in stage 220, method 200 may continue to stage 230 where computing device 400 may determine a height above ground (i.e., DHM) for each of the plurality of trees by subtracting a height of ground associated with each of the plurality of trees determined from a three-dimensional Digital Terrain Model (DTM) from a height of tree associated with each of the plurality of trees determined from the three-dimensional DSM. For example, one way to decide the height of a canopy may be to extract the height in the DSM at the bounding box center of a tree. The center of the bounding box may not necessarily correspond to the highest point of the tree. The height of each tree may be calculated as the mean of the local maxima in the bounding box or an area bigger (e.g., 3 times) than the bounding box size.

The three-dimensional DTM may be created from the three-dimensional DSM that may describe the ground level under forest 110. The DTM may be created, for example, by excluding objects on the ground in the DSM and interpolating between ground points near these objects.

Diameter at Breast Height (DBH) may also be determined and used in calculating volume. DBH may be used to estimate tree volume, basal area, and tree growth because a standing tree may be approximated as a tapered cone or a cylinder. A standardized metric for DBH estimation may be shown below where H may be the height of a tree. Other DBH estimation equation may be used.

$$D B H ∝ \frac{{H}^{3 / 2}}{100} , [ meters ]$$

After computing device 400 determines the height above ground for each of the plurality of trees in stage 230, method 200 may proceed to stage 240 where computing device 400 may determine a volume associated with each of the plurality of trees based on the height of tree associated with each of the plurality of trees and the species data associated with each of the plurality of trees. For example, a statistical relationship may exist of tree stem volume and tree distribution gathered from a specific area (e.g., Colorado) that may have mainly forests of evergreen type for example. Based on a distribution of each tree species and using a volume function for the tree species in the below table, the volume of evergreen and deciduous trees in the area may be estimated with the formula shown below. The volume, V, may be the gross volume in cubic feet of the entire tree stem without branches. DBH may be the diameter at breast height, and H may be the total tree height. The aforementioned is an example and other processes and equations may be used to determine tree volume based on other parameter in other areas of the world (e.g., Texas instead of Colorado).

| Tree species | a | b | c | d | T | σ |
|---|---|---|---|---|---|---|
| Lodgepole pine | 0.00277 | 0.027967 | 0.002332 | 3.446454 | 7000 | ±7.70% |
| Spruce and fir | 0.00239 | 0.06439 | 0.00193 | 10.41663 | 22500 | ±13.24% |
| Ponderosa pine | 0.00226 | 0 | 0 | 0 | — | ±14.16% |
| Aspen | 0.002219 | 0 | 0.001896 | 4.0267 | 12470 | ±11.3% |

$$V ( D B H , H ) = \{ \begin{matrix}a \cdot D B {H}^{2} H + b , & if D B {H}^{2} H \leq T \\ c \cdot D B {H}^{2} H + d , & otherwise\end{matrix}$$

For tree growth detection task, two three-dimensional models may be generated with two sets of satellite images taken in time (e.g., years apart) to determine tree growth detection consistent with embodiments of the disclosure. Accordingly, forest value may be demined and tracked in time. Embodiments of the disclosure may evaluate forest values from an economic, environmental, and sociological aspect. The result may be presented based on evaluating processes for classifying and detecting trees, estimating tree volume, and tree growth. Once computing device 400 determines the volume associated with each of the plurality of trees based on the height of tree associated with each of the plurality of trees and the species data associated with each of the plurality of trees in stage 240, method 200 may then end at stage 250.

FIG. 4 shows computing device 400. As shown in FIG. 4, computing device 400 may include a processing unit 410 and a memory unit 415. Memory unit 415 may include a software module 420 and a database 425. While executing on processing unit 410, software module 420 may perform, for example, processes for providing forestry timber volume estimations as described above with respect to FIG. 2. Computing device 400, for example, may be deployed in in satellite 105. Notwithstanding, computing device 400 may be deployed anywhere and the image data may be transmitted from satellite 105 to a network, for example, and then sent to computing device 400.

Computing device 400 may be implemented using a Wi-Fi access point, a tablet device, a mobile device, a smart phone, a telephone, a remote control device, a set-top box, a digital video recorder, a cable modem, a personal computer, a network computer, a mainframe, a router, a switch, a server cluster, a smart TV-like device, a network storage device, a network relay device, or other similar microcomputer-based device. Computing device 400 may comprise any computer operating environment, such as hand-held devices, multiprocessor systems, microprocessor-based or programmable sender electronic devices, minicomputers, mainframe computers, and the like. Computing device 400 may also be practiced in distributed computing environments where tasks are performed by remote processing devices. The aforementioned systems and devices are examples and computing device 400 may comprise other systems or devices.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the disclosure.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to, mechanical, optical, fluidic, and quantum technologies. In addition, embodiments of the disclosure may be practiced within a general purpose computer or in any other circuits or systems.

Embodiments of the disclosure may be practiced via a system-on-a-chip (SOC) where each or many of the elements illustrated in FIG. 4 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the disclosure, may be performed via application-specific logic integrated with other components of computing device 400 on the single integrated circuit (chip).

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

What is claimed is:

1. A method comprising:
identifying, in a three-dimensional Digital Surface Model (DSM), a plurality of image data associated with a respective plurality of trees;
determining, from the plurality of image data, species data associated with each of the plurality of trees;
determining a height above ground for each of the plurality of trees by subtracting a height of ground associated with each of the plurality of trees determined from a three-dimensional Digital Terrain Model (DTM) from a height of tree associated with each of the plurality of trees determined from the three-dimensional DSM; and
determining a volume associated with each of the plurality of trees based on the height of tree associated with each of the plurality of trees and the species data associated with each of the plurality of trees.

2. The method of claim 1, further comprising determining a value of forest based on the volume associated with each of the plurality of trees.

3. The method of claim 1, further comprising determining a growth of forest based on the volume associated with each of the plurality of trees.

4. The method of claim 1, wherein determining the species data associated with each of the plurality of trees comprises determining the species data based on a canopy size associated with each of the plurality of trees determined from the plurality of image data associated with a respective plurality of trees.

5. The method of claim 1, wherein determining the species data associated with each of the plurality of trees comprises determining the species data based on a color associated with each of the plurality of trees determined from the plurality of image data associated with a respective plurality of trees.

6. The method of claim 1, wherein determining the species data associated with each of the plurality of trees comprises determining the species data based on a texture associated with each of the plurality of trees determined from the plurality of image data associated with a respective plurality of trees.

7. The method of claim 1, wherein determining the species data associated with each of the plurality of trees comprises determining a species associated with each of the plurality of trees.

8. The method of claim 1, wherein the species data comprises one of coniferous and deciduous.

9. The method of claim 1, further comprising determining a Diameter at Breast Height (DBH) for each of the plurality of trees based on the height above ground for each of the plurality of trees.

10. The method of claim 9, wherein determining the volume associated with each of the plurality of trees comprises using the DBH for each of the plurality of trees.

11. The method of claim 1, wherein identifying the plurality of image data associated with the respective plurality of trees comprise using a Machine Learning Model (MLM).

12. The method of claim 1, wherein determining the species data associated with each of the plurality of trees comprise using a Machine Learning Model (MLM).

13. The method of claim 1, wherein identifying the plurality of image data associated with the respective plurality of trees and determining the species data associated with each of the plurality of trees comprise using a Machine Learning Model (MLM).

14. A system comprising:
a memory storage; and
a processing unit coupled to the memory storage, wherein the processing unit is operative to:
identify, in a three-dimensional Digital Surface Model (DSM), a plurality of image data associated with a respective plurality of trees;
determine, from the plurality of image data, species data associated with each of the plurality of trees;
determine a height above ground for each of the plurality of trees by subtracting a height of ground associated with each of the plurality of trees determined from a three-dimensional Digital Terrain Model (DTM) from a height of tree associated with each of the plurality of trees determined from the three-dimensional DSM; and
determine a volume associated with each of the plurality of trees based on the height of tree associated with each of the plurality of trees and the species data associated with each of the plurality of trees.

15. The system of claim 14, wherein the processing unit is further operative to determine a value of forest based on the volume associated with each of the plurality of trees.

16. The system of claim 14, wherein the processing unit is further operative to determine a growth of forest based on the volume associated with each of the plurality of trees.

17. The system of claim 14, wherein the processing unit being operative to determine the species data associated with each of the plurality of trees comprises the processing unit being operative to determine the species data based on a canopy size associated with each of the plurality of trees determined from the plurality of image data associated with a respective plurality of trees.

18. A non-transitory computer-readable medium that stores a set of instructions which when executed perform a method executed by the set of instructions comprising:
identifying, in a three-dimensional Digital Surface Model (DSM), a plurality of image data associated with a respective plurality of trees;
determining, from the plurality of image data, species data associated with each of the plurality of trees;
determining a height above ground for each of the plurality of trees by subtracting a height of ground associated with each of the plurality of trees determined from a three-dimensional Digital Terrain Model (DTM) from a height of tree associated with each of the plurality of trees determined from the three-dimensional DSM; and
determining a volume associated with each of the plurality of trees based on the height of tree associated with each of the plurality of trees and the species data associated with each of the plurality of trees.

19. The non-transitory computer-readable medium of claim 18, wherein determining the species data associated with each of the plurality of trees comprises determining the species data based on a color associated with each of the plurality of trees determined from the plurality of image data associated with a respective plurality of trees.

20. The non-transitory computer-readable medium of claim 18, wherein determining the species data associated with each of the plurality of trees comprises determining the species data based on a texture associated with each of the plurality of trees determined from the plurality of image data associated with a respective plurality of trees.
